(19) United States
(12) Patent Application Publication
(10) Pub. No.: US 2015/0104719 A1
(43) Pub. Date: Apr. 16, 2015

(54) BATTERY MANUFACTURE WITH THE AID OF SPIN COATING

(71) Applicant: Timm Lohmann, Ludwigsburg (DE)

(72) Inventor: Timm Lohmann, Ludwigsburg (DE)

(21) Appl. No.: 14/373,871

(22) PCT Filed: Nov. 30, 2012
(86) PCT No.: PCT/EP2012/074091

§ 371 Date: Jul. 22, 2014

(30) Foreign Application Priority Data
Jan. 23, 2012 (DE) 10 2012 200 862.4

(51) Int. Cl. H01M 12/06; H01M 12/02

(52) U.S. Cl. CPC H01M 12/065; H01M 12/02
USPC 429/403; 429/402; 429/535; 427/58; 156/60

(57) ABSTRACT

A method for manufacturing a galvanic cell or a battery includes: a) applying an anode layer to a current collector layer; b) applying a solid-state ionic conductor layer to the anode layer; c) applying a polymer electrolyte layer to the solid-state ionic conductor layer and/or to the anode layer with the aid of spin coating; and d) applying a cathode layer to the polymer electrolyte layer with the aid of spin coating.

### BACKGROUND OF THE INVENTION

1. Field of the Invention

The present invention relates to a method for manufacturing a galvanic cell or battery, to a lithium and/or gas cell or battery, and to a mobile or stationary system configured therewith.

2. Description of the Related Art

Lithium batteries are presently the subject matter of research since, at 3880 mAh/g, lithium metal has a 10 times higher capacity than lithiated graphite (370 mAh/g). In high-energy batteries, such as lithium-sulfur or lithium-air batteries, this results in practically achievable specific energies of 400 Wh/g and 1000 Wh/g, respectively. This corresponds to an increase in the specific energy by a factor of 3 to 5 over conventional lithium-ion batteries.

### BRIEF SUMMARY OF THE INVENTION

A subject matter of the present invention is a method for manufacturing a galvanic cell or battery, which includes the following method steps:

a) applying an anode layer to a current collector layer;

b) if necessary, applying a solid-state ionic conductor layer to the anode layer;

c) applying a polymer electrolyte layer to the solid-state ionic conductor layer or to the anode layer with the aid of spin coating; and

d) applying a cathode layer to the polymer electrolyte layer, in particular with the aid of spin coating.

The method may in particular be a method for manufacturing a lithium cell or a lithium battery and/or a gas cell or a gas battery. A lithium cell or a lithium battery may be a lithium-oxygen, a lithium-air, a lithium-sulfur and/or a lithium-ion cell or a lithium-oxygen, a lithium-air, a lithium-sulfur and/or a lithium-ion battery, for example. A gas cell or a gas battery may be a lithium-oxygen, a lithium-air, a zinc-oxygen, a zinc-air, a magnesium-oxygen and/or a magnesium-air cell or a lithium-oxygen, a lithium-air, a zinc-oxygen, a zinc-air, a magnesium-oxygen and/or a magnesium-air battery. The method may thus in particular be a method for manufacturing a lithium-oxygen, a lithium-air, a lithium-sulfur, a lithium-ion, a zinc-oxygen, a zinc-air, a magnesium-oxygen or a magnesium-air cell or battery.

A current collector layer may be understood to mean in particular a layer made of an electrically conducting material, such as nickel. It is possible for the current collector layer to also contribute to the mechanical stability of the layer system to be manufactured, for which reason the current collector layer may optionally also be referred to as a carrier layer.

With the method, in particular the spin coating, an intimate bond of the individual functional layers, in particular of the polymer electrolyte layer with the layer composite located beneath, for example the solid-state ionic conductor layer or the anode layer located beneath, and of the cathode layer with the polymer electrolyte layer, is advantageously achievable.

An intimate bond of the functional layers advantageously affects the internal resistance of the cell or battery to be manufactured. Moreover, spin coating allows controlled, homogeneous layers having an extremely thin layer thickness, for example of several 10 nm, and having a low production tolerance to be manufactured. Low layer thicknesses also advantageously affect a reduction of the internal resistance of the cell or battery to be manufactured. Moreover, this allows extremely thin cell stacks to be manufactured. For example, the polymer electrolyte layer may be applied using a very thin layer thickness, for example in the range of approximately 100 nm, which particularly advantageously affects a reduction of the internal resistance.

The internal resistance of lithium cells or lithium batteries manufactured according to the present invention may thus be lower by up to two orders of magnitude than in conventional lithium cells or lithium batteries, in which polymer electrolyte layers having a layer thickness in the range of several μm are pressed by being only placed on or pressed together with other functional layers, such as cathode layers. Moreover, an intimate bond allows the ionic conductivity between individual functional layers to be improved, which makes it possible to dispense with a liquid electrolyte and to provide a liquid electrolyte-free lithium cell or lithium battery, for example. This, in turn, may advantageously increase the safety of the cell or battery since it is possible to avoid combustible organic solvents.

Due to a low internal resistance, a higher rate capability of the cell or battery to be manufactured may advantageously be achieved.

The low production tolerance additionally allows a plurality of cells having a uniform capacity to be manufactured.

By applying a solid-state ionic conductor layer, an anode layer designed as a lithium metal layer may advantageously be encapsulated and protected from environmental influences, for example oxygen. Moreover, growth of dendrites, for example from the lithium metal of the lithium metal layer, is preventable by the solid-state ionic conductor layer.

Overall, the method advantageously allows lithium cells or lithium batteries and/or gas cells or gas batteries having capacities of several Ah to be implemented, which are suitable for use in the automotive field, for example.

The current collector layer, the anode layer, the solid-state ionic conductor layer, the polymer electrolyte layer and the cathode layer may have an essentially round, in particular circular, base surface, for example.

Within the scope of one specific embodiment, the current collector layer, the anode layer, the solid-state ionic conductor layer, the polymer electrolyte layer and the cathode layer are designed to be essentially disk-shaped. In particular, the current collector layer, the anode layer, the solid-state ionic conductor layer, the polymer electrolyte layer and the cathode layer may essentially be designed in the form of circular disks.

Within the scope of one further specific embodiment, the spin coating in method step(s) c) and/or d) is carried out using a low-viscosity polymer solution and/or using a rotational speed of greater than or equal to 3000 rpm, in particular of greater than or equal to 4000 rpm, for example around approximately 5000 rpm. This proved to be advantageous for achieving thin layers.

Within the scope of one further specific embodiment, in method step c) the polymer electrolyte layer is applied to the anode layer in such a way that the anode layer is enclosed between the polymer electrolyte layer and the current collector layer.

Within the scope of one further specific embodiment, in method step b) the solid-state ionic conductor layer is applied to the anode layer in such a way that the anode layer is enclosed between the solid-state ionic conductor layer and the current collector layer.

To achieve enclosure of the anode layer, for example, the current collector layer and the polymer electrolyte layer or the solid-state ionic conductor layer may have a larger surface than the anode layer, the anode layer in particular being able to be formed centrally between the current collector layer and the polymer electrolyte layer or the solid-state ionic conductor layer. It is thus possible to ensure that the edge sections of the current collector layer and of the polymer electrolyte layer or of the solid-state ionic conductor layer contact each other, surrounding and thereby protecting the anode layer.

Within the scope of one further specific embodiment, the method further includes the following method step: e) applying a spacer disk to the cathode layer. The spacer disk may be designed in particular for forming a gas supply to the cathode layer. For this purpose, the spacer disk may be designed in the shape of a ring which is open on at least one side, for example. The ring opening may serve as a gas inlet opening into the interior area of the ring. By applying the spacer disk to a cathode layer that has not yet completely solidified, it is also possible to achieve an intimate bond between the cathode layer and the spacer disk. In this way, on the one hand a gas-tight joint is achievable between the spacer layer and the cathode layer. On the other hand, it is also possible in this way to reduce the internal resistance of the lithium battery to be manufactured since the spacer disk may additionally serve as an electrical conductor for interconnecting multiple individual cells.

Within the scope of one further specific embodiment, the method moreover includes the following method step: f) repeating the method steps a); if necessary b); c); and d), forming a further layer system, which includes a current collector layer, an anode layer, if necessary a solid-state ionic conductor layer, a polymer electrolyte layer and a cathode layer.

Within the scope of one further specific embodiment, the method further includes the following method step: g) stacking two or more layer systems. The layer systems in each case may in particular include a current collector layer, an anode layer, if necessary a solid-state ionic conductor layer, a polymer electrolyte layer and a cathode layer. The layer systems may in particular be stacked in such a way that the galvanic cells formed by the individual layer systems are connected in series. In particular, at least two layer systems may be stacked on top of each other in such a way that the cathode layers of the (two) layer systems contact opposing sides of an interposed spacer disk.

Within the scope of one further specific embodiment, the method further includes the following method step: h) transferring the layer system or the stacked layer systems into a housing. The housing may in particular have a cylindrical shape and be configured with at least one gas inlet opening, for example. The at least one gas inlet opening may be formed in particular on a cover surface of the cylindrical housing. The housing and the layer system or the stacked layer systems may in particular be designed in such a way that an, in particular radial, clearance is formed between the housing, in particular the inner wall of the housing, and the layer system or the stacked layer systems. The cathode layer may advantageously be supplied with gas, in particular oxygen or air, via the at least one gas inlet opening, the clearance and the ring opening(s) of the spacer disk(s). In this way, a gas cell or battery, for example a lithium-oxygen, a lithium-air, a zinc-oxygen, a zinc-air, a magnesium-oxygen or a magnesium-air cell or battery is advantageously implementable in a particularly simple manner.

Within the scope of one further specific embodiment, in method step a) the anode layer is applied to the current collector layer with the aid of thermal vapor deposition and/or by sputtering and/or by lamination and/or by pressing, in particular under vacuum or under a protective gas atmosphere, for example an argon atmosphere. These coating methods have proven to be advantageous for generating an intimate bond between the anode layer and the current collector layer. As previously explained, this bond advantageously affects the internal resistance of the cell or battery to be manufactured.

Within the scope of one further specific embodiment, in method step b) the solid-state ionic conductor layer is applied to the anode layer with the aid of thermal vapor deposition and/or by sputtering and/or by wet-chemical deposition, for example with the aid of a sol-gel method, and/or by gas phase deposition. These coating methods have proven to be advantageous for generating an intimate bond between the solid-state ionic conductor layer and the anode layer and a low layer thickness of the solid-state ionic conductor layer. As previously explained, this bond advantageously affects the internal resistance of the cell or battery to be manufactured.

Method steps c) and/or d), in particular d), may include two or more sub-method steps based on spin coating. In particular a multi-layer cathode layer, for example including multiple layers made of different materials, may thus be implemented.

Within the scope of one further specific embodiment, the current collector layer includes nickel. The current collector layer may in particular be made of nickel.

Within the scope of one further specific embodiment, the anode layer includes lithium, zinc and/or magnesium. If the cell or battery is a zinc-oxygen or zinc-air gas cell or gas battery, the anode layer may be based on, in particular metallic, zinc. If the cell or battery is a magnesium-oxygen or magnesium-air gas cell or gas battery, the anode layer may be based on, in particular metallic, magnesium.

The anode layer may be based on lithium if the cell or battery is a lithium-oxygen, lithium-air, lithium-sulfur or lithium-ion cell or battery. For example, the anode layer may be a lithium metal layer or an intercalation material layer. An intercalation material may be understood to mean in particular a material in which lithium ions may be reversibly inserted and removed again, i.e., intercalated and deintercalated.

The anode layer may in particular be a lithium metal layer. A lithium metal layer may be understood to mean in particular both a layer made of metallic lithium and a layer made of a lithium alloy. For example, the lithium metal layer may include or be made of metallic lithium or a lithium alloy, for example a lithium-aluminum and/or a lithium-silicon alloy.

Within the scope of one further specific embodiment, the cathode layer is a gas diffusion electrode, in particular for a lithium-oxygen, a lithium-air, a zinc-oxygen, a zinc-air, a magnesium-oxygen or a magnesium-air cell, or a sulfur-containing cathode layer, in particular for a lithium-sulfur cell, or a cathode layer including an intercalation material, in particular for a lithium-ion cell. For example, Li(Ni,Mn,Co)O₂ is usable as an intercalation material for a cathode layer for a lithium-ion cell. For example, the cathode layer may include at least one electrically conducting additive, for example carbon black, such as Super P Li or Ketjenblack, and/or at least one binder, in particular at least one lithium ion-conducting polymer (gas diffusion electrode), or at least one sulfur-containing compound, in particular sulfur, and if necessary at least one electrically conducting additive, for example a carbon modification (lithium-sulfur cell cathode), or at least one intercalation material, for example Li(Ni,Mn,Co)O₂, and if necessary at least one electrically conducting additive, for example a carbon modification (lithium-ion cell cathode).

Within the scope of one further specific embodiment, the solid-state ionic conductor layer is lithium ion-conducting. Such a solid-state ionic conductor layer may advantageously protect an anode layer which is based on lithium, in particular a lithium metal layer, from oxygen for example, and/or may prevent a formation of lithium dendrites during the charging process. For example, for this purpose the solid-state ionic conductor layer may include, or be made of, at least one material which is selected from the group composed of lithium phosphorus oxynitride (LiPON), lithium carbonate (Li₂CO₃), lithium tantalum oxide (LiTaO₃), lithium-containing garnets, such as Li₇LaZr₂O₁₂, germanium-containing glass ceramics, such as Li—Ge—P—S or Li—Al—Ge—P—O, and mixtures thereof. Since the solid-state ionic conductor layer is preferably applied in an extremely low layer thickness, the specific lithium ion conductivity of the materials does not necessarily have to be particularly high at room temperature, but may be less than 10⁻³ S/cm, to achieve a low internal resistance. However, the internal resistance may advantageously be reduced further by using materials having a higher lithium ion conductivity.

The spacer disk(s) may in particular be made of an electrically conducting material. For example, the spacer disk(s) may include or be made of a metallic material.

Within the scope of one further specific embodiment, the spacer disk includes aluminum. The spacer disk may in particular be made of aluminum.

Within the scope of one further specific embodiment, the current collector layer has a layer thickness in a range of greater than or equal to 1 μm to less than or equal to 20 μm, in particular of greater than or equal to 1 μm to less than or equal to 10 μm, for example of approximately 5 μm.

Within the scope of one further specific embodiment, the anode layer has a layer thickness in a range of greater than or equal to 10 μm to less than or equal to 150 μm, in particular of greater than or equal to 25 μm to less than or equal to 100 μm, for example of approximately 75 μm.

Within the scope of one further specific embodiment, the solid-state ionic conductor layer has a layer thickness in a range of greater than or equal to 10 nm to less than or equal to 1 μm, in particular of greater than or equal to 10 nm to less than or equal to 100 nm.

Within the scope of one further specific embodiment, the polymer electrolyte layer has a layer thickness in a range of greater than or equal to 50 nm to less than or equal to 10 μm, in particular of greater than or equal to 50 nm to less than or equal to 5 μm.

Within the scope of one further specific embodiment, the cathode layer has a layer thickness in a range of greater than or equal to 10 nm to less than or equal to 150 μm, in particular of greater than or equal to 10 nm to less than or equal to 100 μm.

Within the scope of one further specific embodiment, the spacer disk has a layer thickness in a range of greater than or equal to 50 nm to less than or equal to 200 μm, in particular of greater than or equal to 100 nm to less than or equal to 150 μm, for example of approximately 120 μm.

With respect to additional features and advantages of the method according to the present invention, reference is hereby made explicitly to the descriptions in connection with the galvanic cell or battery according to the present invention and the mobile or stationary system according to the present invention, as well as to the figures and the description of the figures.

A further subject matter of the present invention is a galvanic cell or battery. The galvanic cell or battery may in particular be manufactured with the aid of a method according to the present invention.

For example, it may be a lithium and/or gas cell or a lithium and/or gas battery, for example a lithium-oxygen cell or a lithium-air cell or a lithium-sulfur cell or a lithium-ion cell or a zinc-oxygen cell or a zinc-air cell or a magnesium-oxygen cell or a magnesium-air cell, or a lithium-oxygen battery or a lithium-air battery or a lithium-sulfur battery or a lithium-ion battery or a zinc-oxygen battery or a zinc-air battery or a magnesium-oxygen battery or a magnesium-air battery. The cell or battery may in particular have a capacity of ≧1 Ah, for example of ≧10 Ah. The cell or the battery may in particular be liquid electrolyte-free.

In particular, it may be a gas battery, for example a lithium-oxygen battery or a lithium-air battery or a zinc-oxygen battery or a zinc-air battery or a magnesium-oxygen battery or a magnesium-air battery. It may in particular include a cylindrical housing and a plurality of stacked layer systems.

The layer systems may in each case include a current collector layer, an anode layer, if necessary a solid-state ionic conductor layer, a polymer electrolyte layer and a cathode layer. The current collector layers, the anode layers, if necessary the solid-state ionic conductor layers, the polymer layers and the cathode layers of the layer systems may be designed to be essentially disk-shaped. In particular at least two layer systems may be stacked on top of each other in such a way that the cathode layers of the (two) layer systems contact opposing sides of an interposed spacer disk, which may be designed in particular in the shape of a ring which is open on at least one side.

The layer system stack may in particular be situated or situatable in the housing in such a way that a clearance may be formed radially between the layer system stack and the inner wall of the housing. The cathode layers of the layer systems in particular may be suppliable with a gas, in particular oxygen or air, via at least one gas inlet opening of the housing, the radial clearance and the ring openings of the spacer disks.

With respect to additional features and advantages of the cell or battery according to the present invention, reference is hereby made explicitly to the descriptions in connection with the method according to the present invention and the mobile or stationary system according to the present invention, as well as to the figures and the description of the figures.

A further subject matter of the present invention is a mobile or stationary system which includes or is configured with a cell and/or a battery according to the present invention. In particular, it may be a vehicle, for example a hybrid, a plug-in hybrid or an (all-) electric vehicle, an energy storage system, for example for stationary energy storage, such as in a house or in technical installations, a power tool, an electric gardening tool or an electronic device, such as a notebook, a PDA or a mobile telephone.

With respect to additional features and advantages of the mobile or stationary system according to the present invention, reference is hereby made explicitly to the descriptions in connection with the method according to the present invention and the cell or battery according to the present invention, as well as to the figures and the description of the figures.

### BRIEF DESCRIPTION OF THE DRAWINGS

FIG. 1a shows a schematic cross section through a layer system which is manufactured within the scope of one specific embodiment of method step a) and includes a current collector layer and an anode layer.

FIG. 1b shows a schematic top view onto the layer system shown in FIG. 1a.

FIG. 2a shows a schematic cross section through a layer system which is manufactured within the scope of one specific embodiment of method step b) and includes a current collector layer, an anode layer and a solid-state ionic conductor layer.

FIG. 2b shows a schematic top view onto the layer system shown in FIG. 2a.

FIG. 3a shows a schematic cross section through a layer system which is manufactured within the scope of one specific embodiment of method step c) and includes a current collector layer, an anode layer, a solid-state ionic conductor layer and a polymer electrolyte layer.

FIG. 3b shows a schematic top view onto the layer system shown in FIG. 3a.

FIG. 4a shows a schematic cross section through a layer system which is manufactured within the scope of one specific embodiment of method step d) and includes a current collector layer, an anode layer, a solid-state ionic conductor layer, a polymer electrolyte layer and a cathode layer.

FIG. 4b shows a schematic top view onto the layer system shown in FIG. 4a.

FIG. 5a shows a schematic cross section through a layer system which is manufactured within the scope of one specific embodiment of method step e) and includes a current collector layer, an anode layer, a solid-state ionic conductor layer, a polymer electrolyte layer, a cathode layer and a spacer disk.

FIG. 5b shows a schematic top view onto the layer system shown in FIG. 5a.

FIG. 6a shows a schematic cross section through a gas battery which is manufacturable by one specific embodiment of method step h) and includes a cylindrical housing and a plurality of stacked layer systems.

FIG. 6b shows a schematic top view onto the gas battery shown in FIG. 6a.

### DETAILED DESCRIPTION OF THE INVENTION

Within the scope of the description of the figures, one specific embodiment of the method is explained, within the scope of which a lithium metal layer is used as the anode layer and a lithium-oxygen or lithium-air battery is manufactured.

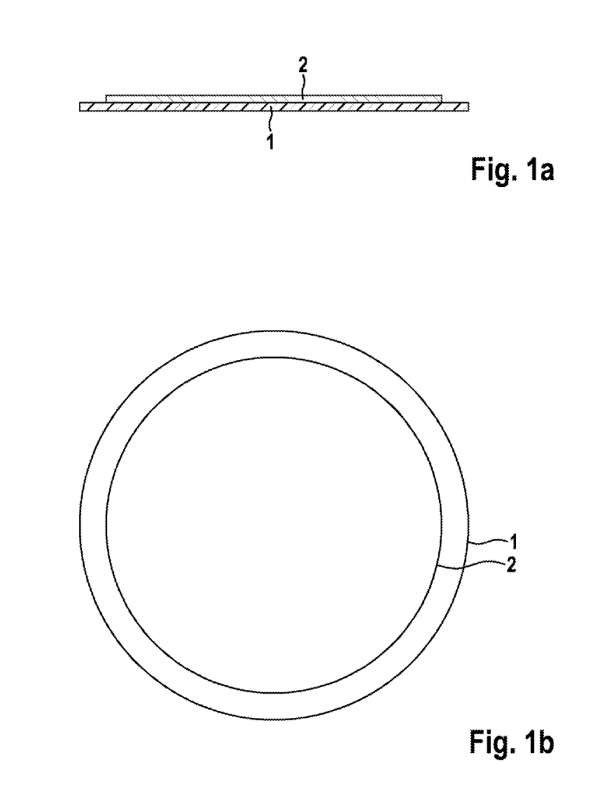

FIGS. 1a and 1b illustrate that, for the manufacture of an individual cell, initially in a method step a) a lithium metal foil 2, for example having a layer thickness of 75 μm, is applied to a current collector layer 1 in the form of a nickel carrier foil, for example having a layer thickness of 5 μm, to generate the anode of the lithium cell to be manufactured. This may be carried out, for example, with the aid of vapor deposition under vacuum or sputtering or by lamination or by pressing under argon. For example, a 75 μm thick lithium metal foil 2 may have a theoretical surface capacity of 9.7 mAh/cm², taking 50% lithium excess into account.

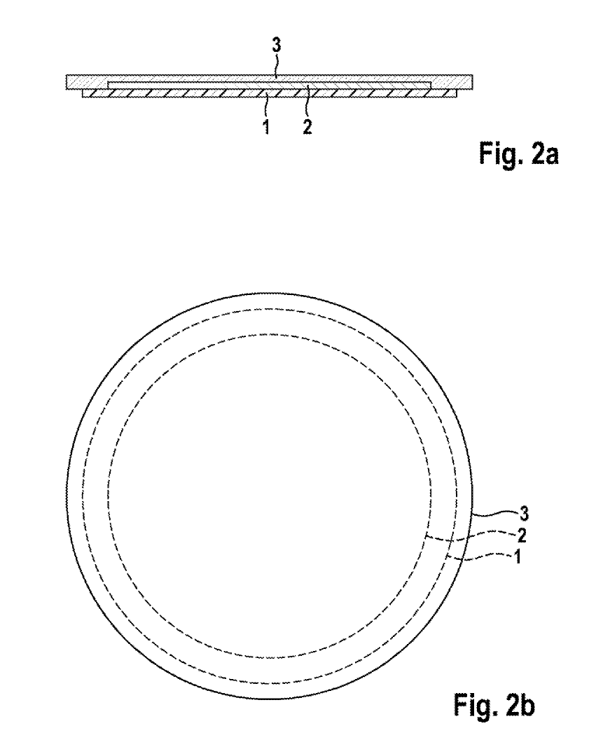

FIGS. 2a and 2b illustrate that the lithium metal anode 1, 2 thus prepared is coated in a method step b) with a ceramic or polymeric solid-state ionic conductor 3, for example lithium phosphorus oxynitride (LiPON) and/or lithium carbonate (Li₂CO₃). FIGS. 2a and 2b show that lithium 2 here is completely enclosed between solid-state ionic conductor 3 and nickel foil 1. This coating serves as a protective layer to protect the highly reactive lithium from aggressive substances such as oxygen.

This is relevant in particular for lithium-oxygen, lithium-air and lithium-sulfur cells since here side reactions with oxygen or sulfur could lead to capacity losses. In the case of lithium-oxygen or lithium-air cells, moreover side reactions with nitrogen, water and carbon dioxide may be problematic, for which reason an anode protective layer is particularly important here. Possible application methods for solid-state ionic conductor 3 are thermal vapor deposition, sputtering, wet-chemical deposition or gas phase deposition. The layer thickness of solid-state ionic conductor layer 3 is preferably selected in such a way that sufficient absolute ionic conductivity may be assured. The exact layer thickness should thus be matched to the specific ionic conductivity of the material which is used. The layer thickness of solid-state ionic conductivity layer 3 may range between several 10 nm and 1 μm, for example. Possible application methods are thermal vapor deposition, sputtering, wet-chemical deposition or gas phase deposition.

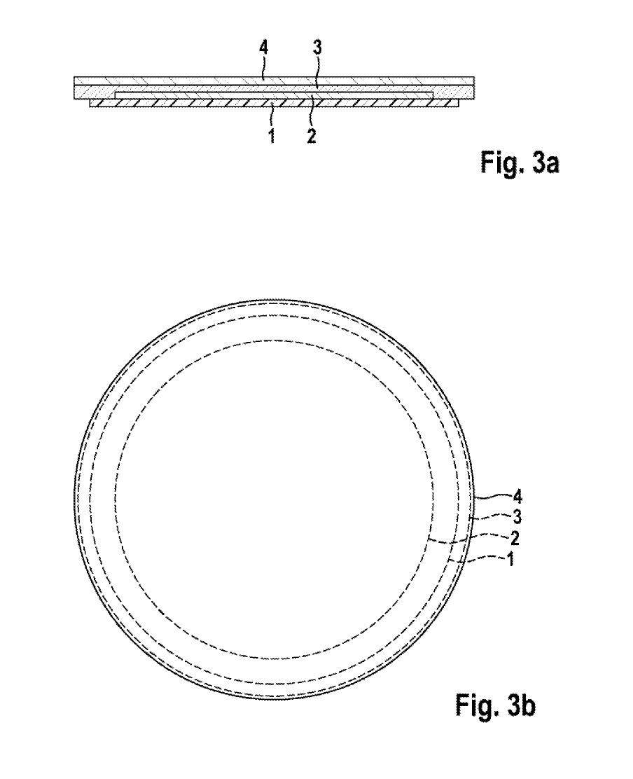

FIGS. 3a and 3b illustrate that a polymer electrolyte layer 4 is applied to solid-state ionic conductor layer 3 in a method step c). For this purpose, lithium metal anode 1, 2, 3, which was coated and thereby encapsulated and is shown in FIGS. 2a and 2b, may be spin-coated with a polymer electrolyte layer 4 with the aid of a so-called “spin coater.” Using low-viscosity polymer solutions and, for example, rotational speeds around 5000 rpm, layer thicknesses of less than 100 nm, for example from 50 nm to several μm, may thus be reproducibly manufactured. The exact process parameters should be matched to the polymer which is used. Process parameters relevant for the layer thickness are the viscosity of the polymer solution, the rotational speed of the “spin coater” and the rotation duration. Since the polymer solution is directly applied to solid-state ionic conductor 3 and solvent may partially evaporate during rotation, good adhesion is thus achievable between solid-state ionic conductor 3 and polymer electrolyte 4. In addition to a controlled small layer thickness in the nanometer range, the spin coating moreover allows a good bond between the layers as well as the implementation of a low internal resistance of the cell. Polymer electrolyte layer 4 may additionally serve as an adhesion promoter between solid-state ionic conductor 3 and cathode layer 5 applied thereto in subsequent method step d).

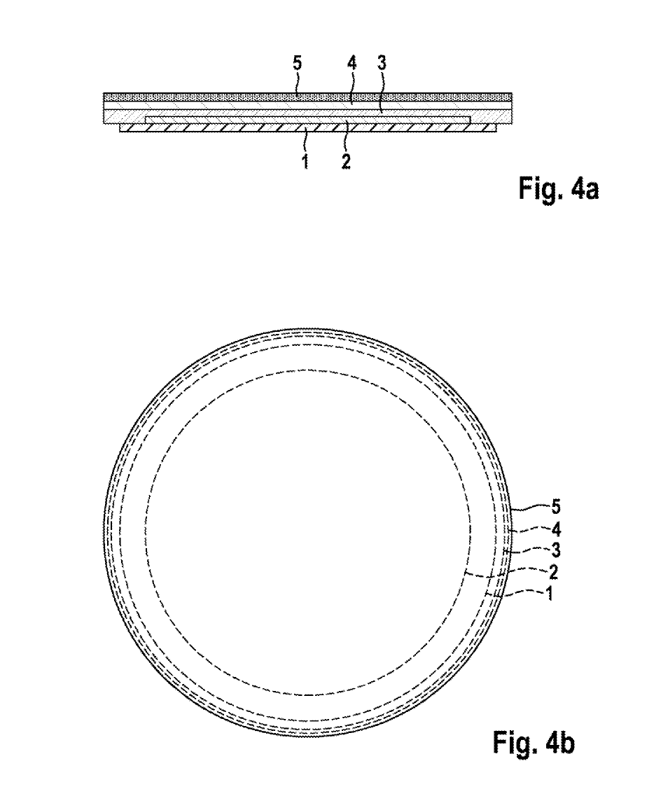

FIGS. 4a and 4b show that in method step d) a cathode layer 5 in the form of a gas diffusion electrode (GDL) is applied to polymer electrolyte layer 4. As was already described, cathode layer 5 is not limited to the form of a gas diffusion electrode, but it is also possible to design cathode layer 5 in the form of a cathode for lithium-sulfur cells or for conventional lithium-ion cells, for example using oxidic cathode materials. As an alternative to a design of cathode layer 5 as a gas diffusion electrode, cathode layer 5 may thus, for example, also be designed as a sulfur-containing cathode layer, which includes carbon and sulfur, for example, or as a cathode layer including an intercalation material, which includes carbon and LiCoO₂, for example. Cathode layer 5 may also be applied with the aid of spin coating, in particular to the not yet fully cured polymer electrolyte layer 4. In this way, advantageously also an intimate bond between cathode layer 5 and polymer electrolyte layer 4, and thus a low transition impedance, may be achieved. The slip for cathode layer 5 may include carbon black, for example, such as Super P Li or Ketjenblack, binder, for example a lithium ion-conducting polymer, and further additives if necessary. As a result of the spin coating, it is possible to adjust the layer thickness of cathode layer 5 very precisely in the range from 10 μm to 100 μm. The layer thickness variation across the entire sample may be less than 500 nm. This advantageously allows lithium cells having an easily reproducible capacity to be manufactured.

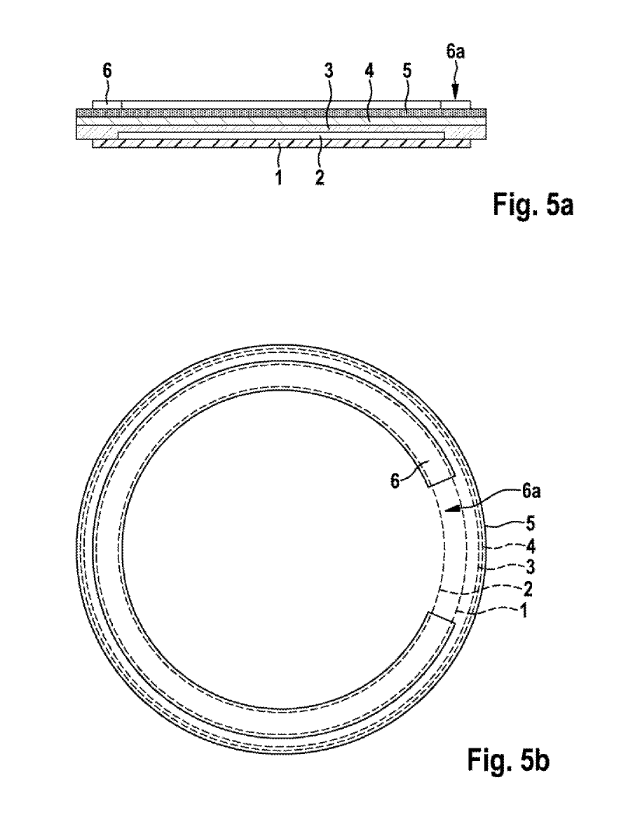

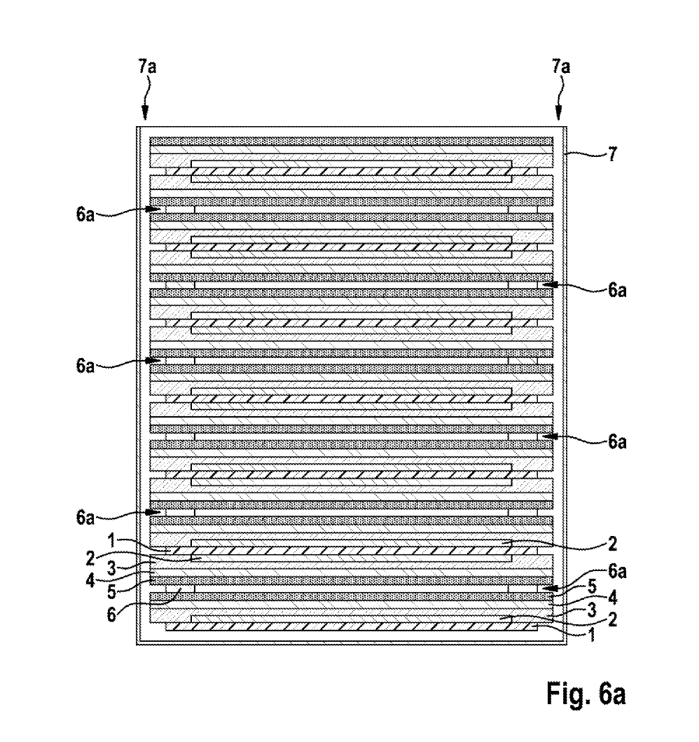

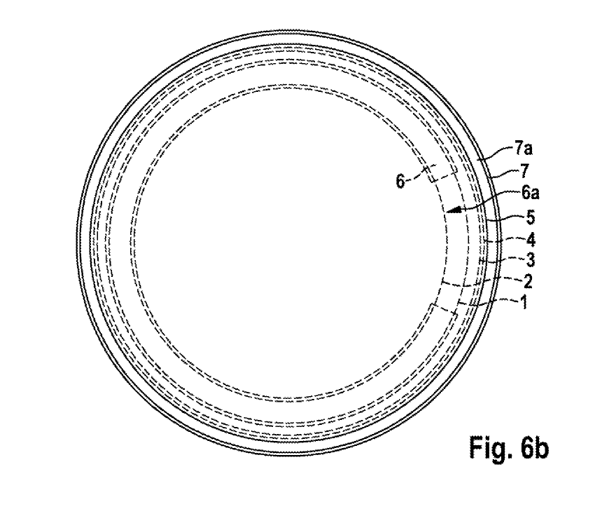

FIGS. 5a and 5b illustrate that in a method step e) a spacer disk 6, for example made of aluminum, for example having a thickness of 120 μm, is applied to cathode layer 5, which is designed in the shape of a ring which is open on one side and serves to form a gas supply to cathode layer 5. Such a spacer disk 6 may in particular be advantageous when multiple individual cells, as shown in FIGS. 6a and 6b, are assembled to form a cell stack. A spacer disk 6 is preferably provided when a cathode layer 5 is present in the form of a gas diffusion electrode and may be used in particular to supply cathode layer 5 with gas, for example oxygen or air. If cathode layer 5 is a sulfur-containing cathode layer or a cathode layer including an intercalation material, spacer disk 6 may be dispensed with since in these cases the active material, for example sulfur or LiCoO₂, is present in cathode layer 5 from the start, and does not have to be supplied from the gas phase as in the case of a gas diffusion electrode.

FIGS. 6a and 6b show a lithium battery which has a cylindrical housing 7 and includes a stack of a plurality of layer systems shown in FIGS. 4a and 4b. Each layer system includes an essentially disk-shaped current collector layer 1, an anode layer (lithium metal layer) 2, a solid-state ionic conductor layer 3, a polymer electrolyte layer 4 and a cathode layer 5, the cathode layer being designed in particular in the form of a gas diffusion electrode. For this purpose, two layer systems 1, 2, 3, 4, 5 in each case are stacked on top of each other in such a way that cathode layers 5 of the two layer systems 1, 2, 3, 4, 5 contact opposing sides of an interposed spacer disk 6. As is shown in FIGS. 5a and 5b, spacer disks 6 are designed in the shape of an open ring and serve as a gas supply for cathode layers 5 adjoining thereon. In other words, two layer systems 1, 2, 3, 4, 5 in each case share one spacer disk 6. The arrows on the right and left sides of the system indicate that spacer disks 6 are situated in such a way that ring openings 6a, which serve as the gas inlet opening into the interior area of spacer disk 6, are formed alternately on opposing sides. Since spacer disks 6 may in particular be made of an electrically conducting material, for example aluminum, the individual galvanic cells formed by individual layer systems 1, 2, 3, 4, 5 may be connected in series by interposed spacer disks 6. FIGS. 6a and 6b further illustrate that a clearance is formed radially between stacked layer systems 1, 2, 3, 4, 5 and the inner wall of housing 7. Gas inlet openings 7a are provided on the cover side or top side of cylindrical housing 7. Gas, in particular oxygen or air, is able to flow through these gas inlet openings 7a into the radial clearance between stacked layer systems 1, 2, 3, 4, 5 and the inner wall of housing 7. The gas is then able to flow from this clearance through the alternately formed ring openings 6a of spacer disks 6 into the interior areas, which are formed in each case by one spacer disk 6 and the two cathode layers 5 adjoining thereon on opposing sides, and are electrochemically converted there at cathode layers 6.

1-15. (canceled)

16. A method for manufacturing one of a galvanic cell or a battery, comprising:
a) applying an anode layer to a current collector layer;
b) applying a solid-state ionic conductor layer to the anode layer;
c) applying a polymer electrolyte layer to at least one of the solid-state ionic conductor layer and the anode layer with the aid of spin coating; and
d) applying a cathode layer to the polymer electrolyte layer with the aid of spin coating.

17. The method as recited in claim 16, wherein at least one of the spin coating in step c) and the spin coating in step d) is carried out using at least one of a low-viscosity polymer solution and a rotational speed of at least 3000 rpm.

18. The method as recited in claim 16, wherein the current collector layer, the anode layer, the solid-state ionic conductor layer, the polymer electrolyte layer, and the cathode layer are essentially disk-shaped.

19. The method as recited in claim 16, wherein one of:
in method step c), the polymer electrolyte layer is applied to the anode layer in such a way that the anode layer is enclosed between the polymer electrolyte layer and the current collector layer; or in method step b), the solid-state ionic conductor layer is applied to the anode layer in such a way that the anode layer is enclosed between the solid-state ionic conductor layer and the current collector layer.

20. The method as recited in claim 16, further comprising:
e) applying a spacer disk to the cathode layer, the spacer disk being configured at least one of (i) in the shape of an open ring and (ii) for forming a gas supply to the cathode layer.

21. The method as recited in claim 20, further comprising:
f) repeating the method steps a), b), c), and d);
whereby at least two layer systems are formed, each layer system including a current collector layer, an anode layer, a solid-state ionic conductor layer, a polymer electrolyte layer, and a cathode layer.

22. The method as recited in claim 21, further comprising:
g) stacking the at least two layer systems in such a way that the galvanic cells formed by the individual layer systems are connected in series, wherein the at least two layer systems are stacked on top of each other in such a way that the cathode layers of the at least two layer systems contact opposing sides of the interposed spacer disk.

23. The method as recited in claim 22, further comprising:
h) transferring the stacked layer systems into a housing which has at least one gas inlet opening.

24. The method as recited in claim 22, wherein in method step a), the anode layer is applied to the current collector layer at least one of: with the aid of thermal vapor deposition; by sputtering; by lamination; and by pressing.

25. The method as recited in claim 22, wherein in method step b), the solid-state ionic conductor layer is applied to the anode layer at least one of: with the aid of thermal vapor deposition; by sputtering; by wet-chemical deposition; and by gas phase deposition.

26. The method as recited in claim 22, wherein the anode layer includes at least one of lithium, zinc and magnesium.

27. The method as recited in claim 22, wherein the cathode layer is one of:
a gas diffusion electrode for at least one of a lithium-oxygen cell, a lithium-air cell, a zinc-oxygen cell, a zinc-air cell, a magnesium-oxygen cell, and a magnesium-air cell; or
a sulfur-containing cathode layer for a lithium-sulfur cell; or
a cathode layer including an intercalation material for a lithium-ion cell.

28. The method as recited in claim 22, wherein at least one of:
the current collector layer has a layer thickness between 1 μm and 20 μm;
the anode layer has a layer thickness between 10 μm and 150 μm;
the solid-state ionic conductor layer has a layer thickness between 10 nm and 1 μm;
the polymer electrolyte layer has a layer thickness between 50 nm and 10 μm;
the cathode layer has a layer thickness between 10 nm and 150 μm; and
the spacer disk has a layer thickness between 50 nm and 200 μm.

29. The method as recited in claim 22, wherein at least one of:
the current collector layer includes nickel;
the solid-state ionic conductor layer is lithium ion-conducting; and
the spacer disk includes aluminum.

30. A gas battery configured as one of a lithium-oxygen, a lithium-air, a lithium-sulfur, a lithium-ion, a zinc-oxygen, a zinc-air, a magnesium-oxygen, or a magnesium-air battery, comprising:
a cylindrical housing; and
at least two layer systems each including a disk-shaped current collector layer, a disk-shaped anode layer, a disk-shaped solid-state ionic conductor layer, a disk-shaped polymer electrolyte layer, and a disk-shaped cathode layer;
wherein the at least two layer systems are stacked on top of each other in such a way that the cathode layers of the at least two layer systems contact opposing sides of an interposed spacer disk in the shape of a ring which is open on at least one side;
wherein the stacked at least two layer systems are situated in the housing in such a way that a clearance is formed radially between the stacked at least two layer systems and an inner wall of the housing; and
wherein the cathode layers of the at least two layer systems are supplied with a gas via (i) at least one gas inlet opening of the housing, (ii) the radial clearance, and (ii) the ring opening of the spacer disk.
